(19) United States
(12) Patent Application Publication
(10) Pub. No.: US 2026/0131714 A1
(43) Pub. Date: May 14, 2026

(54) LEG REST MASSAGE DEVICE FOR VEHICLE SEAT

(71) Applicant: HYUNDAI TRANSYS INC., Seosan-si (KR)

(72) Inventors: Gu Chang KANG, Hwaseong-si (KR); Seong Yun YEO, Incheon (KR); J Edgar CALINGACION, Osan-si (KR)

(21) Appl. No.: 19/032,370

(22) Filed: Jan. 20, 2025

(30) Foreign Application Priority Data
Feb. 2, 2024 (KR) 10-2024-0016655

(51) Int. Cl. B60N 2/90; A61H 15/00

(52) U.S. Cl. CPC B60N 2/976; A61H 15/0078; B60N 2/995; A61H 2015/0021; A61H 2201/1207; A61H 2205/106

(57) ABSTRACT

A leg rest massage device includes a bracket based on which the leg rest massage is to be installed on a vehicle seat, a calf fixing ring configured to support a calf of a passenger to be seated on the vehicle seat, the calf fixing ring movable outwardly and inwardly, a driving unit including a driving shaft and one or more motor carriers driven by the driving unit, the driving shaft configured to be installed in a longitudinal direction of a bracket, and the motor carriers located facing each other on the driving shaft, and a moving unit coupled to the motor carriers. The moving unit is movable outwardly and inwardly in conjunction with movement of the motor carriers in the longitudinal direction of the bracket. The moving unit includes one or more rollers installed thereon, the rollers configured to be moved outwardly and inwardly to massage the calf of the passenger.

### CROSS-REFERENCE TO RELATED APPLICATION

This application claims, under 35 U.S.C. §119(a), the benefit of priority from Korean Patent Application No. 10-2024-0016655, filed on February 2, 2024, the entire contents of which are incorporated herein by reference.

### BACKGROUND

### (a) Technical Field

The present disclosure relates to a leg rest massage device for a vehicle seat, and more particularly, to a massage device installed on a vehicle seat and configured to rub the calves of a passenger sitting on the vehicle seat, in which the massage device is configured to improve blood flow to the lower extremities and to prevent calf edema by providing direct pressure to the calves of the passenger.

### (b) Background Art

When a passenger sits on a vehicle seat for a long time, the passenger feels uncomfortable due to the continued feeling of pressure on a body portion of the passenger, which is in close contact with the seat, leading to stiffness in the upper and lower body of the passenger, muscle pain, and the like. In order to solve the above-described problems, a seat massage device capable of massaging the passenger's body is installed in the seats of some luxury vehicles.

The seat massage device is mainly installed inside a seatback, which is in close contact with the back and waist of the passenger, and a seat cushion, which is in close contact with the hips and thighs of the passenger, among the plurality of seat components.

As an example of a seat massage device of the related art, a plurality of air cells is installed in the seatback and the seat cushion, thereby performing massage by expanding and contracting the air cells.

As another example of the seat massage device of the related art, a cylinder that is movable in the forward-and-rearward direction by driving of a motor is installed in the seatback and the seat cushion, thereby performing massage using striking force of the cylinder.

As described above, the seat massage device of the related art is mainly installed either in the seatback or in the seat cushion, or in both the seatback and the seat cushion forming the seat. In this manner, the massage may be easily performed on the upper body including the back and the waist of the passenger and the lower body including the hips and the thighs of the passenger.

However, since the seat massage device of the related art is mainly installed either in the seatback or in the seat cushion, or in both the seatback and the seat cushion forming the seat, there is a problem in that the calves of the passenger may not be massaged.

Accordingly, when the passenger sits on the vehicle seat for a long time, the passenger may feel uncomfortable because the flow of blood to the calves of the passenger is impeded, which may problematically increase passenger fatigue.

There is increasing demand for implementation of a massage function in a vehicle seat for passenger convenience, and various massage functions have been researched and developed to improve passenger comfort.

Currently, seat components or calf rests are applied to many vehicle models so as to provide an appropriate sitting posture for the passenger.

FIGS. 1A and 1B are diagrams each showing a conventional seat leg rest.

As shown in FIGS. 1A and 1B, a seat leg rest includes a plate 11 that comes into contact with the calves of a passenger. The seat leg rest may support the calves of the passenger by lifting the plate 11 and may provide a comfortable posture for the passenger.

Meanwhile, although the conventional seat leg rest may provide a comfortable posture for the passenger by supporting the calves of the passenger, this seat leg rest may not directly reduce the fatigue of the passenger.

In addition, general leg rests have been developed in many industries other than the vehicle seat industry. For example, there is a leg rest configured to wrap the calves of the passenger using an air bladder and to apply pressure to the air bladder so as to massage the calves.

However, it is difficult to apply these general leg rests to a vehicle seat. For example, since the conventional leg rest is installed on the vehicle seat, the passenger has limited space to use, and it is difficult to effectively implement the function of the vehicle package space. In addition, when the above-mentioned conventional structure that wraps the passenger's legs with the air bladder is applied to the vehicle seat, the structure may cause inconvenience to the passenger when the passenger enters and exits the vehicle. Further, the conventional structure may cause hinderance when the passenger escapes from the vehicle in the event of vehicle collision, emergency, and the like. In consideration of the above-described problems, it is difficult to install the conventional leg rest device in the vehicle.

The above information disclosed in this Background section is only for enhancement of understanding of the background of the disclosure, and therefore it may contain information that does not form the prior art that is already known in this country to a person of ordinary skill in the art.

### SUMMARY OF THE DISCLOSURE

The present disclosure has been made in an effort to solve the above-described problems associated with the prior art, and it is an object of the present disclosure to provide a leg rest massage device capable of being installed in a vehicle.

Another object of the present disclosure is to provide a massage device capable of being installed in a vehicle without spatial constraints and utilizing the vehicle space.

Still another object of the present disclosure is to provide a massage device capable of massaging the passenger's legs in a state of wrapping the legs. Accordingly, even if the massage device is installed in a vehicle, the passenger may safely escape from the vehicle in the event of emergency.

The objects of the present disclosure are not limited to the above-mentioned objects, and other technical objects not mentioned herein will be clearly understood by those skilled in the art to which the present disclosure pertains from the detailed description of the embodiments. Additionally, the objects of the present disclosure may be achieved by means and combinations thereof as indicated in the claims.

In one aspect, the present disclosure provides a leg rest massage device including a bracket based on which the leg rest massage is to be installed on a vehicle seat, a calf fixing ring configured to support a calf of a passenger to be seated on the vehicle seat, the calf fixing ring configured to be moved outwardly and inwardly, a driving unit including a driving shaft and at least one or more motor carriers driven by the driving unit, the driving shaft configured to be installed in a longitudinal direction of the bracket, and the motor carriers located facing each other on the driving shaft, and a moving unit coupled to the motor carrier, the moving unit being configured to be moved outwardly and inwardly in conjunction with movement of the motor carrier in the longitudinal direction of the bracket, wherein the moving unit includes at least one or more rollers installed thereon, the rollers being configured to be moved outwardly and inwardly to massage the calf of the passenger.

In an example embodiment, the driving unit may include a driving motor configured to be driven by an electrical signal, the driving shaft fixed to the bracket using holders respectively installed at a first end and a second end of the driving shaft, and the motor carriers configured to be movable along the driving shaft in a direction away from each other or toward each other.

In another example embodiment, the at least one pair of the rollers is a pair of rollers configured to compress the calf of the passenger, links connected to the respective rollers and installed to cross each other in an X shape, each of the links having a guide groove formed to penetrate one surface thereof, push wires inserted into the respective guide grooves of the links, each of the push wires being configured to be moved along a corresponding one of the guide grooves so as to adjust an angle of the links, and fixed parts coupled to the respective motor carriers, the fixed parts being configured to move the respective push wires by operation of the respective motor carriers.

In still another example embodiment, the moving unit may include links installed to cross each other in an X shape, the links being assembled with a link hinge located at a central cross point of the links, and each of the links may include a straight guide groove formed on one surface thereof.

In yet another example embodiment, the bracket may include a rail part formed in the longitudinal direction thereof, and the motor carriers may be slidably movable along the rail part.

In still yet another example embodiment, the rail part may include a hole formed to pass through one surface thereof, and the calf fixing ring may be fixed to the hole.

In a further example embodiment, each of the motor carriers may have a concave groove formed to accommodate the calf fixing ring as the calf fixing ring may be slidably moved in the longitudinal direction of the bracket.

In another further example embodiment, each of the rollers may include a central hole formed in a central portion thereof, a roller wire may be inserted into the central holes of the rollers so as to connect at least one pair of the rollers, and the roller wire may be provided for each of the at least one pair of the rollers.

In still another further example embodiment, each of the rollers may have a massage area determined by a length of a corresponding one of the guide grooves formed in the respective links.

In yet another further example embodiment, a force applied to the calf of the passenger may be determined by an area covered by each of the rollers of the moving unit during rotation, and a process of releasing the applied force may be repeatedly performed to provide a massage function.

In still yet another further example embodiment, a rotational speed of each of the rollers may be determined by a movement speed of each of the motor carriers along the longitudinal direction of the bracket.

In a still further example embodiment, the calf fixing ring may be formed with a concave portion configured to face the bracket, and a convex portion of the calf of the passenger may be fitted into the concave portion of the calf fixing ring.

In a yet still further example embodiment, the leg rest massage device may further include a case configured to accommodate the calf fixing ring, the driving unit, the moving unit, and the bracket.

In another example embodiment, the leg rest massage device may further include a sheet covering the case.

In still another example embodiment, the case may be rotatably moved by 90 degrees.

Other aspects and example embodiments of the disclosure are discussed infra.

It is understood that the terms "vehicle", "vehicular", and other similar terms as used herein are inclusive of motor vehicles in general, such as passenger automobiles including sport utility vehicles (SUVs), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, vehicles powered by both gasoline and electricity.

The above and other features of the disclosure are discussed infra.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIGS. 1A and 1B are diagrams each showing a conventional leg rest for a vehicle seat;

FIG. 2 is a diagram showing a leg rest massage device for a vehicle seat according to the present disclosure;

FIG. 3 is a diagram showing a state in which the leg rest massage device for a vehicle seat according to the present disclosure does not compress the calves of a passenger and is moved inwardly from the upper surface of a leg rest in the height direction;

FIG. 4 is a diagram showing a state in which the leg rest massage device for a vehicle seat according to the present disclosure compresses the calves of the passenger and is moved outwardly from the upper surface of the leg rest in the height direction;

FIG. 5 is a diagram showing the leg rest massage device for a vehicle seat according to the present disclosure;

FIG. 6 is a cross-sectional view taken along line A-A' in FIG. 5;

FIG. 7A is a diagram showing a state in which the leg rest massage device for a vehicle seat is moved outwardly from the upper surface of the leg rest in the height direction; and

FIG. 7B is a diagram showing a state in which the leg rest massage device for a vehicle seat is moved inwardly from the upper surface of the leg rest in the height direction.

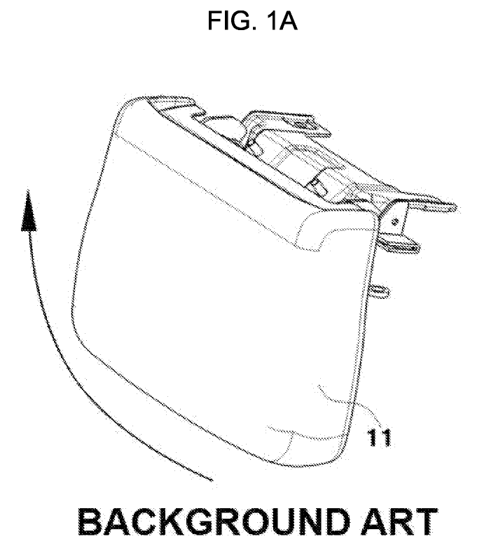

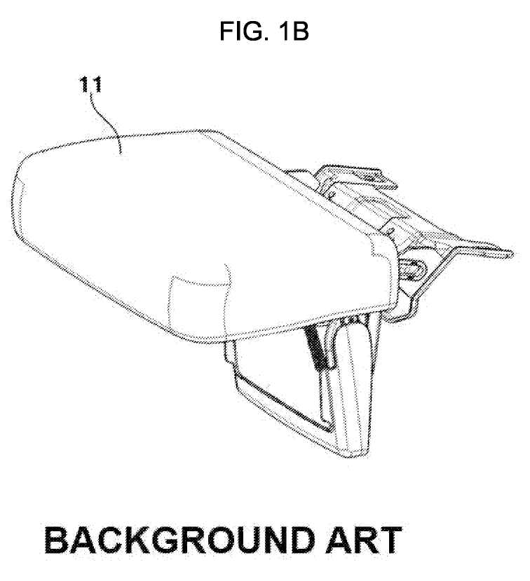

It should be understood that the appended drawings are not necessarily to scale, presenting a somewhat simplified representation of various example features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Hereinafter, reference will be made in detail to various embodiments of the present disclosure, examples of which are illustrated in the accompanying drawings and described below. While the disclosure will be described in conjunction with exemplary embodiments, it will be understood that the present description is not intended to limit the disclosure to the exemplary embodiments. On the contrary, the disclosure is intended to cover not only the exemplary embodiments, but also various alternatives, modifications, equivalents, and other embodiments, which may be included within the spirit and scope of the disclosure as defined by the appended claims. The present embodiments are provided to more fully explain the disclosure to those of ordinary knowledge in the art.

Terms such as "part", "unit", and "module" described in the specification mean a unit configured to process at least two functions or operations, and the unit may be implemented by hardware or software or a combination of hardware and software.

The terms used in the specification are merely used to describe specific embodiments and are not intended to limit the embodiments. Singular forms are intended to include plural forms as well, unless the context clearly indicates otherwise.

Meanwhile, in this specification, terms such as "first" and "second" are used to describe various components having the same names, and the terms are used only for the purpose of distinguishing one component from other components. The components are not limited by the terms in the following description.

Hereinafter, embodiments will be described in detail with reference to the accompanying drawings. In describing the embodiments with reference to the accompanying drawings, the same or corresponding components will be denoted by the same reference numerals and redundant description thereof will be omitted.

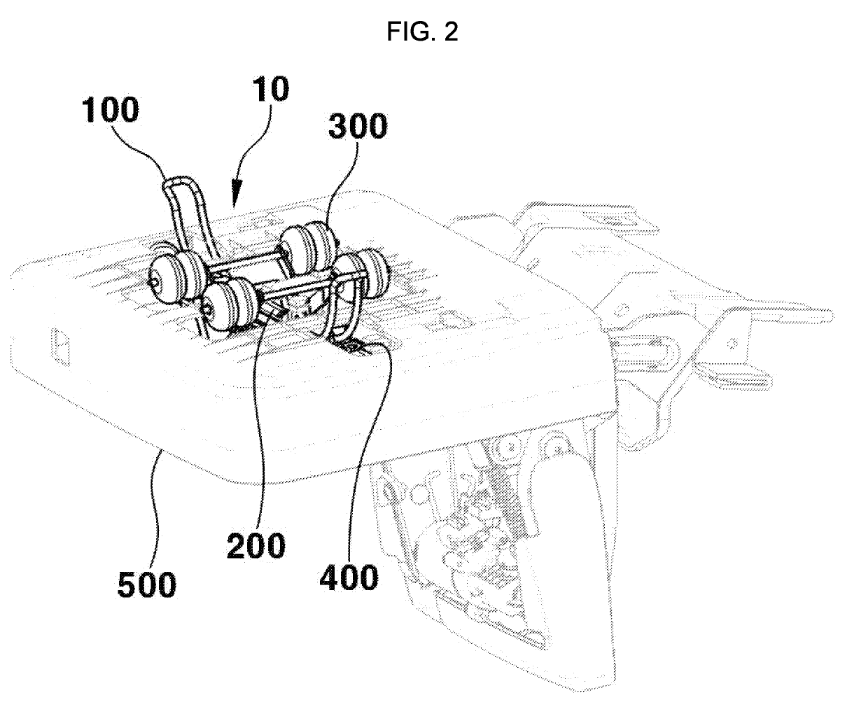

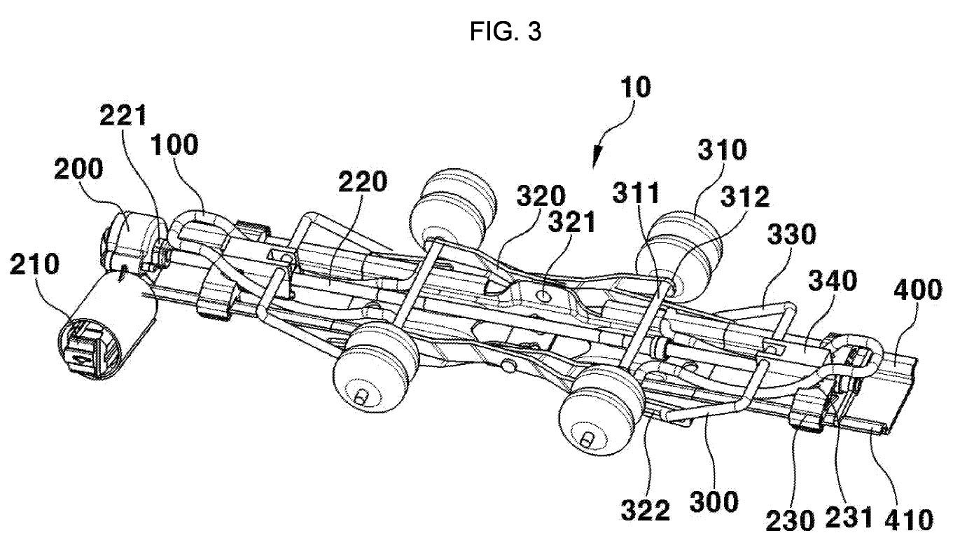

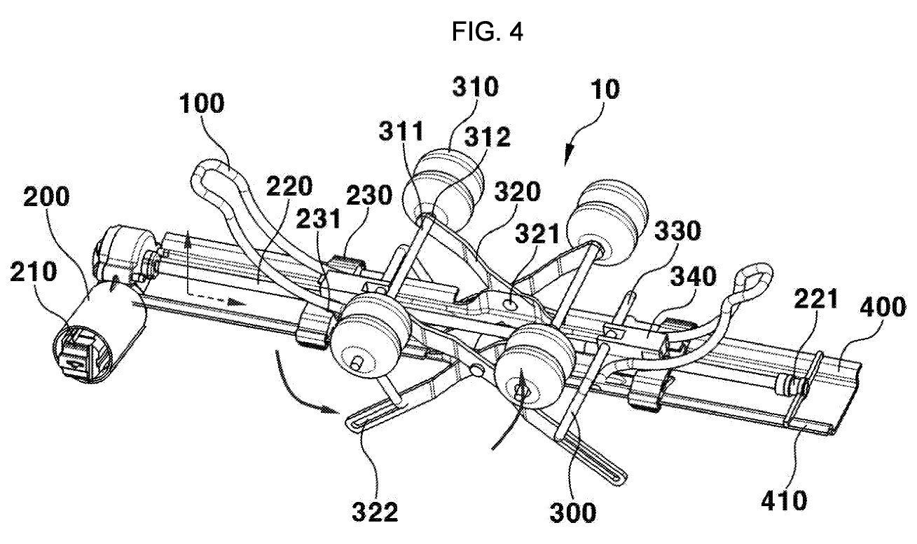

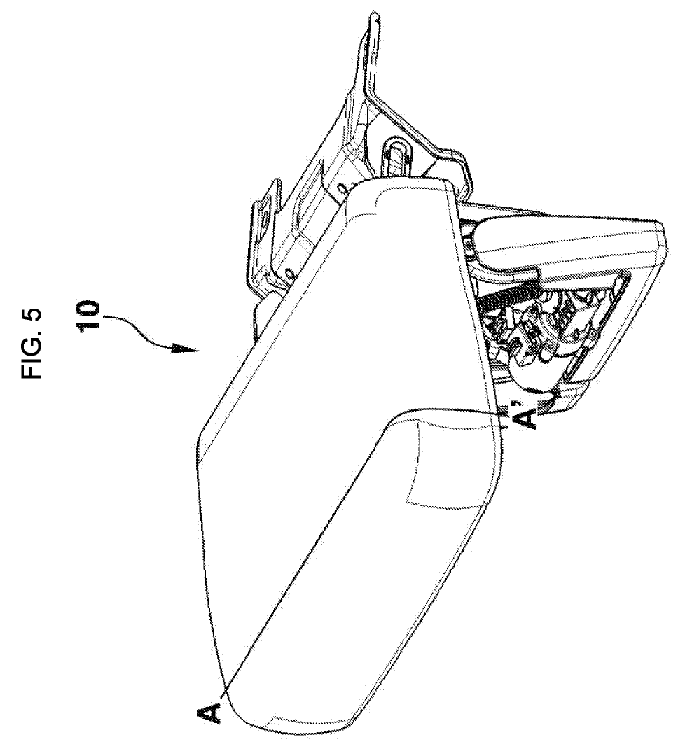

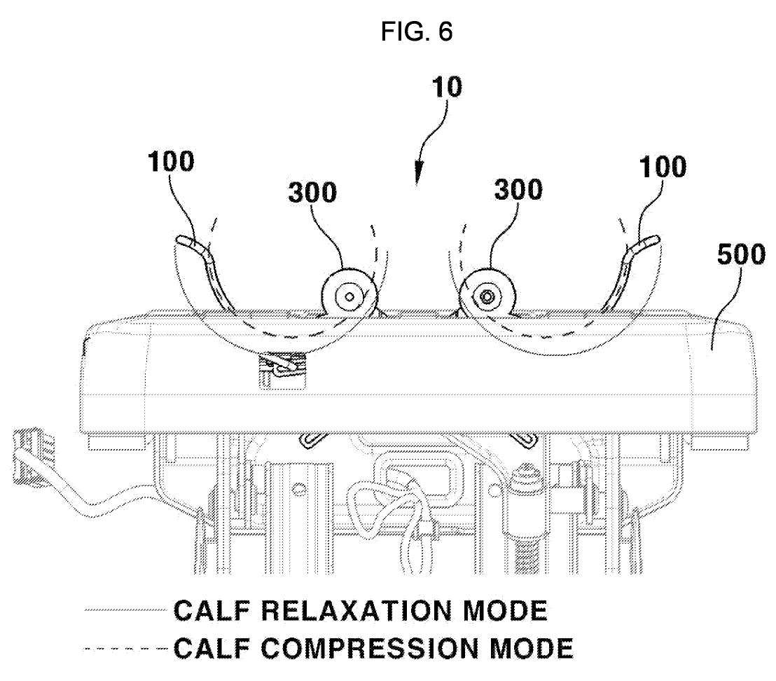

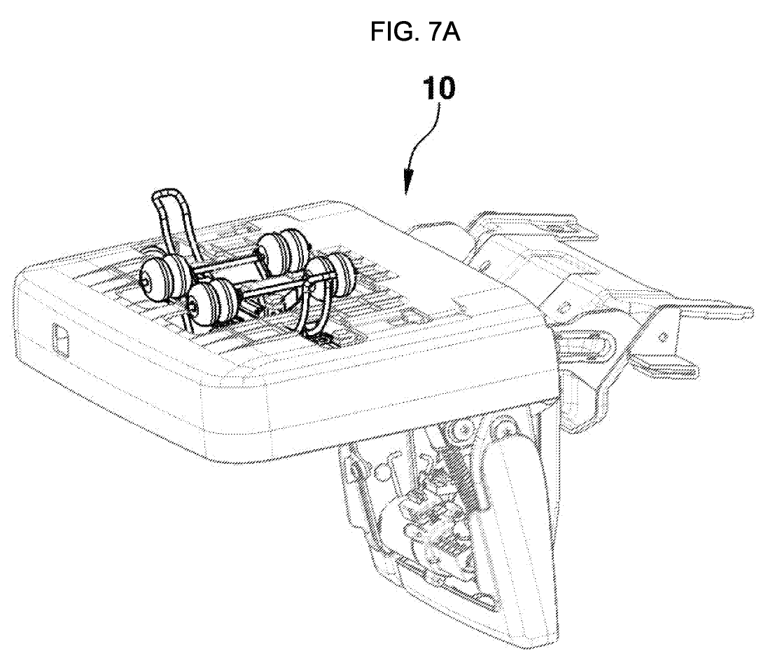

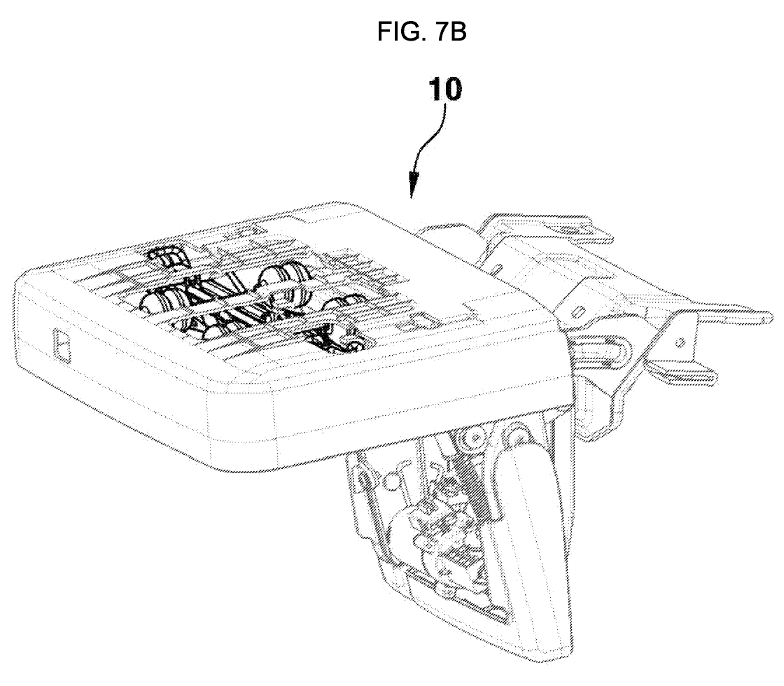

FIG. 2 is a diagram showing a leg rest massage device for a vehicle seat according to the present disclosure, FIG. 3 is a diagram showing a state in which the leg rest massage device for a vehicle seat according to the present disclosure does not compress the calves of a passenger and is moved inwardly from the upper surface of a leg rest in the height direction, FIG. 4 is a diagram showing a state in which the leg rest massage device for a vehicle seat according to the present disclosure compresses the calves of the passenger and is moved outwardly from the upper surface of the leg rest in the height direction, FIG. 5 is a diagram showing the leg rest massage device for a vehicle seat according to the present disclosure, FIG. 6 is a cross-sectional view taken along line A-A' in FIG. 5, FIG. 7A is a diagram showing a state in which the leg rest massage device for a vehicle seat is moved outwardly from the upper surface of the leg rest in the height direction, and FIG. 7B is a diagram showing a state in which the leg rest massage device for a vehicle seat is moved inwardly from the upper surface of the leg rest in the height direction.

First, as shown in FIG. 2, a leg rest massage device 10 for a vehicle seat according to an embodiment of the present disclosure includes a calf fixing ring 100, a driving unit 200, and a moving unit 300. The leg rest massage device 10 may further include a bracket 400 configured for installation of the calf fixing ring 100, the driving unit 200, and the moving unit 300 on the vehicle seat, and a case 500 configured to accommodate the calf fixing ring 100, the driving unit 200, the moving unit 300, and the bracket 400 therein.

First, the case 500 of the leg rest massage device 10 is coupled to the seat on which the passenger sits and is configured to be rotatable so as to support the calves of the passenger.

Specifically, the case 500 of the leg rest massage device 10 of the present disclosure is configured to be coupled to the seat, to receive an electrical signal from a remote control (not shown) or a control module (not shown), and to be vertically rotated on the seat in response to the electrical signal.

Here, the remote control or the control module may further include an angle adjustment module installed therein and configured to adjust the rotation angle of the case 500 coupled to the seat, and a controller installed therein and configured to enable a user to designate a massage time or a massage pattern of the leg rest massage device 10 and to adjust pressing force and a pressing force cycle of the leg rest massage device 10. Here, since vehicle collision may occur while the leg rest massage device 10 is operated, the remote control or the control module may further include a blocking module installed therein and configured to quickly cut off the power in the event of emergency.

Meanwhile, the sheet of the leg rest massage device 10 of the present disclosure is a portion that comes into contact with the legs of the passenger. The sheet of the massage device 10 may be made of any one of cloth, leather, and sponge, and may be made of a highly elastic material.

Referring to FIGS. 2 to 4, the calf fixing ring 100 of the leg rest massage device 10 according to the embodiment of the present disclosure may be configured to support a calf of the passenger to be seated thereon. Here, an area of the calf fixing ring on which the calf is seated may be moved outwardly and inwardly. The shape of the calf fixing ring 100 of the massage device 10 may prevent the calf of the passenger from being pushed outwards, and the area on which the calf is seated may be formed as an empty space so as to allow the calf to be stably seated thereon. Further, the calf fixing ring 100 may be formed in the ring shape having a curved portion such that a convex portion of the calf is fitted into a concave portion of the calf fixing ring 100.

In addition, the calf fixing ring 100 of the massage device 10 according to the present disclosure is fixed to the bracket 400 to be described later, and the calf fixing ring 100 is slidably movable into a concave groove 231 of a motor carrier 230.

Next, the driving unit 200 of the leg rest massage device 10 according to the present disclosure is built into the vehicle seat and includes a driving motor 210, a driving shaft 220, and the motor carrier 230.

The driving motor 210 of the driving unit 200 is mounted in the case 500. Here, the driving motor 210 is driven by an electrical signal of a remote control or a control module, converts rotational motion into linear reciprocating motion, and drives at least one or more motor carriers 230 installed on the driving shaft 220 in a direction away from each other or toward each other.

The driving shaft 220 of the driving unit 200 is mounted in the longitudinal direction of the bracket 400. A first end of the driving shaft 220 is connected to the driving motor 210, and a second end thereof is fixed to the bracket 400 using a holder 221. In addition, the driving shaft 220 may be formed in the shape of a rod having a predetermined diameter. However, depending on implementation of the driving shaft 220, the driving shaft 220 may be formed in the shape of a rectangular parallelepiped rod, and any shape may be adopted as long as the motor carrier 230 is slidably movable along the driving shaft 220.

The motor carriers 230 of the driving unit 200 are configured to be located facing each other and to be movable along the driving shaft 220 in a direction away from each other or toward each other. Specifically, the motor carriers 230 of the driving unit 200 are fitted to the driving shaft 220 and are installed in a rail part 410 of the bracket 400 so as to be movable left and right in the longitudinal direction of the bracket 400. Here, the motor carriers 230 installed therein are moved in opposite directions. For example, when the motor carrier 230 located on the left side is moved to the left, the motor carrier 230 located on the right side is moved to the right. In this manner, two motor carriers 230 are moved away from each other. Conversely, when the motor carrier 230 located on the left side is moved to the right, the motor carrier 230 located on the right side is moved to the left. In this manner, two motor carriers 230 are moved closer to each other.

In addition, the motor carrier 230 of the present disclosure may have the concave groove 231 formed in one surface thereof on which the calf fixing ring 100 is seated. With respect to the shape of the concave groove 231 of the motor carrier 230, since the calf fixing ring 100 is formed in a ring shape having a circumference, the concave groove 231 of the motor carrier 230 may also be formed in a curved shape having a curvature corresponding to a curvature of the calf fixing ring 100. Additionally, the concave groove 231 of the motor carrier 230 serves to allow the calf fixing ring 100 to be slidably moved therealong when the calf fixing ring 100 is moved outwardly or inwardly from the upper surface of the leg rest in the height direction. Meanwhile, a fixed part 340 and the concave groove 231 may be formed as a single injection-molded product and may be provided to be movable along the driving shaft 220. In addition, when the motor carrier 230 is moved, a link 320 is moved outwardly due to movement of a push wire 330 connected to the fixed part 340, and a roller 310 coupled to the link 320 is also moved outwardly.

The moving unit 300 of the leg rest massage device 10 according to the present disclosure is moved outwardly and inwardly when the motor carrier 230 is coupled to the moving unit 300 and the motor carrier 230 is moved in the longitudinal direction of the bracket 400. Specifically, at least a pair of the moving units 300 is provided. Here, the moving unit 300 includes the rollers 310 configured to compress a calf of the passenger, the links 320 respectively connected to the rollers 310, installed to cross each other in the X shape, each of the links having a guide groove 322 formed therein and configured to penetrate one surface of the link, the push wire 330 inserted into the guide groove 322 of each of the links 320 and moved along the guide groove 322 so as to adjust the angle of each of the links 320, and the fixed part 340 connected to the motor carrier 230 and configured to move the push wire 330 by operation of the motor carrier 230

First, at least one pair of the rollers 310 of the moving unit 300 of the present disclosure is provided and is configured to compress and relax the calf of the passenger through repeated upward movement and downward movement thereof. In addition, a central hole 312 is formed in a central portion of each of the rollers 310 of the present disclosure, and a roller wire 311 is inserted into the central hole 312. Specifically, referring to FIGS. 3 and 4, the roller wires 311 are coupled to the central holes 312 formed in the respective rollers 310 so as to move the rollers 310 in the same direction (upward direction or downward direction). In addition, the links 320 are coupled to the respective roller wires 311 so as to enable the rollers 310 to be moved outwardly or inwardly by operation of the links 320.

The links 320 of the moving unit 300 of the present disclosure are coupled to the respective roller wires 311 inserted into the center holes 312 formed in the respective rollers 310. Here, the links are installed to cross each other in the X shape in the direction of the bracket 400 from the respective roller wires 311. Further, each of the links 320 has the guide groove 322 formed to penetrate one surface thereof. Specifically, at least one or more links 320 of the moving unit 300 are provided, and the links 320 are provided to cross each other in the X shape with a link hinge 321 located at a central cross point of the links 320 and configured to couple the links 320 to each other. Here, a plurality of X-shaped links 320 may be provided depending on the number of rollers 310 to be installed, and the number of links is not limited to the specific number. Meanwhile, the link hinge 321 may be provided to fix the links 320 coupled to each other in the X shape and may change the angle of the links 320 through hinge movement.

Each of the links 320 of the moving unit 300 may have one end connected to the roller wire 311 and the other end not connected to the roller wire 311 and formed to have the guide groove 322 provided therein. Here, the guide groove 322 may be formed as a straight groove penetrating one surface of the link. The push wire 330, which will be described later, may be inserted into and coupled to the guide groove 322 of the link 320. When the push wire 330 is moved along the guide groove 322 of the link 320, the roller 310 may be moved outwardly or inwardly. Meanwhile, the degree of upward-and-downward movement of the roller 310 in the the height direction may be determined by the length of the guide groove 322 formed in the link 320 of the present disclosure. Further, a degree of force that applies pressure to the calf of the passenger may be adjusted by the height at which the roller 310 is moved outwardly or inwardly.

The push wire 330 of the moving unit 300, which is inserted into the guide groove 322 of the link 320, is moved along the guide groove 322 and serves to adjust the angle of the X-shaped links 320. Specifically, when the push wire 330 of the moving unit 300 is moved along the guide groove 322 of the link 320, the push wire 330 may be moved inwardly in the direction toward the holder 221 of the driving shaft 220 or may be moved outwardly in the direction toward the link hinge 321 of the link 320. For example, as shown in FIG. 3, when the push wire 330 is moved by the motor carrier 230 toward the end of the holder 221 of the driving shaft 220, the link 320 coupled to the push wire 330 is moved inwardly, and the roller 310 coupled to the link 320 is also moved inwardly. Conversely, when the push wire 330 is moved by the motor carrier 230 in a direction opposite to the end of the holder 221 of the driving shaft 220, the link 320 coupled to the push wire 330 is moved outwardly, and the roller 310 coupled to the link 320 is also moved outwardly. Therefore, the push wire 330 is driven along the guide groove 322, and the link 320 is moved outwardly or inwardly through friction between the push wire 330 and the guide groove 322.

Meanwhile, the push wire 330 of the present disclosure is located in contact with the calf fixing ring 100, and the calf fixing ring 100 is moved by driving of the motor carrier 230. In this manner, the calf fixing ring 100 and the roller 310 are moved outwardly. Here, there is no friction or interference between the calf fixing ring 100 and the push wire 330 during upward movement and downward movement.

The fixed part 340 of the moving unit 300 of the present disclosure is configured to be coupled to the motor carrier 230, to be coupled to the push wire 330, and to move the push wire 330 in the direction toward the link hinge 321 by movement of the motor carrier 230. The fixed part 340 of the moving unit 300 has a hole formed therein and configured for the push wire 330 to pass therethrough, and is assembled with the motor carrier 230. Therefore, the fixed part 340 of the moving unit 300 is configured to perform an operation of moving the push wire 330 outwardly or inwardly by operation of the motor carrier 230. The fixed part 340 is employed to firmly support the power of the motor carrier 230. In addition, the fixed part 340 may be formed to be integrated with the concave groove 231 and may be movable along the driving shaft.

The bracket 400 of the leg rest massage device 10 according to the present disclosure is coupled to the seat and is built into the case 500. Further, the bracket has the rail part 410 formed in the longitudinal direction thereof. Specifically, the bracket 400 has the rail part 410 formed in the longitudinal direction thereof and configured for the motor carrier 230 to be slidably moved in the left and right directions along the rail part. Further, the bracket 400 has a stepped portion formed thereon and configured for the motor carrier 230 to be fitted thereinto and moved therealong. In this manner, the motor carrier 230 is assembled with the bracket 400 through the stepped portion. Therefore, through the rail part 410 including the stepped portion, the motor carrier 230 may be smoothly movable left and right in the longitudinal direction of the bracket 400. In addition, holes penetrating the rail part 410 of the bracket 400 of the present disclosure are formed, and the holes are located facing each other. The calf fixing ring 100 is inserted into the holes such that the calf fixing ring 100 is moved outwardly or inwardly. In this manner, the height of the calf fixing ring 100 from the upper surface of the leg rest may vary depending on upward movement and downward movement of the calf fixing ring 100.

Hereinafter, a detailed description will be given as to driving of the leg rest massage device 10 of the present disclosure.

FIG. 5 is a diagram showing the leg rest massage device for a vehicle seat according to the present disclosure, FIG. 6 is a cross-sectional view taken along line A-A' in FIG. 5, FIG. 7A is a diagram showing a state in which the leg rest massage device for a vehicle seat is moved outwardly from the upper surface of the leg rest in the height direction, and FIG. 7B is a diagram showing a state in which the leg rest massage device for a vehicle seat is moved inwardly from the upper surface of the leg rest in the height direction.

First, referring to FIGS. 5 and 6, FIG. 6 is a cross-sectional view of the leg rest massage device 10 in FIG. 5, taken along line A-A'. In FIG. 6, a dotted line indicates that the roller 310 of the moving unit 300 operates in the semicircular curved shape in the calf relaxation mode, and a solid line indicates that the roller 310 of the moving unit 300 operates in the semicircular curved shape in the calf compression mode.

Referring to FIG. 6, the leg rest massage device 10 receives a driving signal from a passenger and continuously performs an operation of compressing and relaxing the calves of the passenger. Specifically, the moving unit 300 of the leg rest massage device 10 is moved outwardly and inwardly by the driving signal. When the roller 310 of the moving unit 300 is moved outwardly and is driven in the semicircular curved shape, the calves of the passenger are compressed. Conversely, when the moving unit 300 is moved inwardly, the roller 310 is also moved inwardly, and the calves of the passenger are relaxed. In this manner, it is possible to achieve an effect of improving blood flow to the lower extremities of the passenger and preventing calf edema through repetition of compressing and relaxing the calves of the passenger.

In addition, depending on implementation of the leg rest massage device 10 of the present disclosure, it is possible to appropriately adjust, in response to a driving signal input by the passenger, the driving time of the leg rest massage device so as to compress and relax the calves of the passenger for longer or shorter periods.

Meanwhile, as shown in FIG. 7A and FIG. 7B, the leg rest massage device 10 may be configured in such a manner that, when a passenger operates a remote control or a control module to drive the massage device 10, the massage device protrudes convexly from the seat so as to perform a massage operation of compressing and relaxing the calves of the passenger, and when the passenger does not use the massage device 10, the massage device 10 is placed inside the case 500.

As described above, the leg rest massage device 10 of the present disclosure is configured to be coupled to the vehicle seat and installed inside the case 500. Accordingly, the leg rest massage device 10 may be installed in the vehicle without spatial constraints. Further, since the leg rest massage device 10 has a compact size and light weight, manufacturing costs may be reduced. Additionally, since the leg rest massage device 10 has a simple structure, a manufacturing process thereof may be simple, and production efficiency may be improved.

Additionally, the leg rest massage device 10 has a function of directly massaging the calves of the passenger, thereby improving blood flow to the lower extremities of the passenger and preventing calf edema.

Finally, since the leg rest massage device 10 is accommodated in the seat when not in use, the passenger easily enters and exits the vehicle without interference with the leg rest massage device.

As is apparent from the above description, the present disclosure may achieve the following effects by the configuration, combination, and use relationship described in the embodiments.

The present disclosure provides a leg rest massage device capable of being installed in a vehicle. Further, the leg rest massage device may be installed in the vehicle without spatial constraints and may utilize the vehicle space.

Furthermore, the leg rest massage device is capable of massaging the passenger's legs in a state of wrapping the legs. Accordingly, even if the leg rest massage device is installed in the vehicle, the passenger may safely escape from the vehicle in the event of emergency.

The present disclosure has been described in detail with reference to example embodiments thereof, and the present disclosure may be used in various other combinations, modifications, and environments. That is, it will be appreciated by those skilled in the art that changes may be made in these embodiments without departing from the principles and spirit of the disclosure, the scope of which is defined in the appended claims and equivalents thereto. The embodiments describe the best mode to implement the technical idea of the present disclosure, and various changes required in specific application fields and uses of the present disclosure are also possible. Accordingly, the detailed description of the present disclosure is not intended to limit the present disclosure to the disclosed embodiments. Additionally, the scope of the appended claims should be construed as including other embodiments as well.

What is claimed is:

1. A leg rest massage device comprising:
a bracket based on which the leg rest massage is to be installed on a vehicle seat;
a calf fixing ring configured to support a calf of a passenger to be seated on the vehicle seat, the calf fixing ring configured to be moved outwardly and inwardly;
a driving unit comprising a driving shaft and at least one or more motor carriers driven by the driving unit, the driving shaft configured to be installed in a longitudinal direction of the bracket, and the motor carriers located facing each other on the driving shaft; and
a moving unit coupled to the motor carrier, the moving unit configured to be moved outwardly and inwardly in conjunction with movement of the motor carrier in the longitudinal direction of the bracket,
wherein the moving unit includes at least one or more rollers installed thereon, the rollers configured to be moved outwardly and inwardly to massage the calf of the passenger.

2. The leg rest massage device of claim 1, wherein the driving unit further comprises
a driving motor configured to be driven by an electrical signal,
wherein the driving shaft is fixed to the bracket using holders respectively installed at a first end and a second end of the driving shaft; and
wherein the motor carriers are configured to be movable along the driving shaft in a direction away from each other or toward each other.

3. The leg rest massage device of claim 1, wherein the at least one or more rollers is a pair of rollers configured to compress the calf of the passenger, and
wherein the moving unit further comprises:
links connected to the respective rollers and installed to cross each other in an X shape, each of the links having a guide groove formed to penetrate one surface thereof;
push wires inserted into the respective guide grooves of the links, each of the push wires configured to be moved along a corresponding one of the guide grooves so as to adjust an angle of the links; and
fixed parts coupled to the respective motor carriers, the fixed parts configured to move the respective push wires by operation of the respective motor carriers.

4. The leg rest massage device of claim 1, wherein:
the moving unit includes links installed to cross each other in an X shape, the links assembled with a link hinge located at a central cross point of the links, and
each of the links includes a straight guide groove formed on one surface thereof.

5. The leg rest massage device of claim 1, wherein the bracket includes a rail part formed in the longitudinal direction thereof, and the motor carriers are configured to be slidably movable along the rail part.

6. The leg rest massage device of claim 5, wherein the rail part includes a hole formed to pass through one surface thereof, and the calf fixing ring is configured to be fixed to the hole.

7. The leg rest massage device of claim 5, wherein each of the motor carriers includes a concave groove formed with a curvature to accommodate a curvature of the calf fixing ring as the calf fixing ring is slidably moved in the longitudinal direction of the bracket.

8. The leg rest massage device of claim 1, wherein each of the rollers includes a central hole formed in a central portion thereof, a roller wire is inserted into the central holes of the rollers so as to connect at least one pair of the rollers, and the roller wire is provided for each of the at least one pair of the rollers.

9. The leg rest massage device of claim 3, wherein each of the rollers has a massage area determined by a length of a corresponding one of the guide grooves formed in the respective links.

10. The leg rest massage device of claim 1, wherein a force applied to the calf of the passenger is determined by an area covered by each of the rollers of the moving unit during rotation, and a process of releasing the applied force is repeatedly performed to provide a massage function.

11. The leg rest massage device of claim 1, wherein a rotational speed of each of the rollers is determined by a movement speed of each of the motor carriers along the longitudinal direction of the bracket.

12. The leg rest massage device of claim 1, wherein the calf fixing ring is formed with a concave portion configured to face the bracket, and a convex portion of the calf of the passenger is fitted into the concave portion of the calf fixing ring.

13. The leg rest massage device of claim 1, further comprising a case configured to accommodate the calf fixing ring, the driving unit, the moving unit, and the bracket.

14. The leg rest massage device of claim 13, further comprising a sheet covering the case.

15. The leg rest massage device of claim 13, wherein the case is rotatably moved by 90 degrees.
